(19) United States
(12) Patent Application Publication
(10) Pub. No.: US 2007/0258427 A1
(43) Pub. Date: Nov. 8, 2007

(54) WIRELESS COMMUNICATION METHOD AND SYSTEM FOR ACTIVATING MULTIPLE SERVICE BEARERS VIA EFFICIENT PACKET DATA PROTOCOL CONTEXT ACTIVATION PROCEDURES

(75) Inventors: Kamel M. Shaheen, King of Prussia, PA (US); Guang Lu, Dollard-des-Ormeaux (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/734,514

(22) Filed: Apr. 12, 2007

Related U.S. Application Data
(60) Provisional application No. 60/839,532, filed on Aug. 23, 2006.
(60) Provisional application No. 60/797,154, filed on May 3, 2006.

(51) Int. Cl. H04Q 7/24

(52) U.S. Cl. 370/338

(57) ABSTRACT

A method and apparatus for executing attachment procedures in a long term evolution (LTE) system to accommodate a single tunnel approach. Third Generation Partnership Program (3GPP) packet data protocol (PDP) context activation procedures are used for the allocation of an Internet protocol (IP) address and the establishment of tunneling between an evolved Node-B (eNodeB) and an anchor node, while allowing multiple radio access bearers (RABs) to be mapped to one PDP context for different quality of service (QoS) requirements. Thus, one PDP context is sufficient for a wireless transmit/receive unit (WTRU) within a single packet data network (PDN). Multiple PDP contexts can be established for special requirements, (e.g., bundled services), or when the WTRU connects to multiple PDNs.

### CROSS REFERENCE TO RELATED APPLICATIONS

This application claims the benefit of U.S. Provisional Application No. 60/797,154 filed on May 3, 2006 and U.S. Provisional Application No. 60/839,532 filed on Aug. 23, 2006, which are incorporated by reference as if fully set forth.

### FIELD OF INVENTION

The present invention generally relates to wireless communication systems. More particularly, the present invention is related to methods and apparatus for activating multiple service bearers using a single secondary packet data protocol (PDP) context activation procedure in a Third Generation Partnership Project (3GPP) system, (i.e., General Packet Radio Service (GPRS) and Universal Mobile Telecommunications System), and Long Term Evolution (LTE) systems. The procedures can be implemented in a GPRS dual tunnel approach and in a direct tunnel approach in GPRS and LTE systems.

### BACKGROUND

Traditionally, cellular networks were designed for voice services only. GPRS supports some types of data services, such as text messaging and emails. However, more data services and multimedia services are being introduced as applications running on cellular networks, such as Voice over Internet Protocol (VoIP), Internet Protocol (IP) television (IPTV), or the like. Cell phones are changing from a voice service phone to a converged data centric device, and the cellular network is evolving towards the next generation of all IP networks and packet services with IP multimedia subsystem (IMS) infrastructure. Besides the need for a higher data rate, the cellular network also needs the architecture changes required to support IP applications and packet-switched (PS) services more efficiently, (i.e., reducing delays due to multiple setup procedures and delay time for services data traffic due to excessive processing at the various nodes of the network).

FIGS. 1-3 show signaling in a conventional wireless communication system 100 including a wireless transmit/receive unit (WTRU) 105, a radio access network (RAN) 110, a serving general packet radio service (GPRS) support node (SGSN) 115 and a gateway GPRS support node (GGSN) 120. One packet data protocol (PDP) context is associated with one radio access bearer (RAB) for a 3GPP PS service. Thus, to support multiple services, one primary PDP context activation and multiple secondary PDP context activation procedures are needed to enable these services, as illustrated by FIGS. 1-3, which are described by 3GPP technical specification (TS) 23.060. For example, the data subscriber who wishes to connect to IMS-based services, (i.e., VoIP, multimedia, and the like), and at the same time activates Web browsing, e-mail service, fax service, and the like, has to perform a separate PDP context activation for each service. By the time all of the services are running, the subscriber may have waited for a considerable amount of time, similar to waiting for a computer to boot up.

Currently for the 3GPP PS service, one PDP context is associated with one RAB. Thus to support multiple services, one primary context and multiple secondary PDP contexts need to be activated, as shown in FIGS. 1 and 2. Furthermore, to support IMS services, a primary PDP context for session initiated protocol (SIP) signaling and secondary PDP context for each data service, (to be activated), is always needed.

### SUMMARY

The present invention provides a method and apparatus for 3GPP systems, (i.e., GPRS, UMTS), and LTE systems, to reduce service setup delays due to the multiple serial setup procedures and processing delay time for data traffic services due to excessive processing at the various nodes of the network. The present invention proposes a simplified secondary PDP context activation procedure that activates several services in a single step. The present invention re-uses the current 3GPP PDP context activation procedures for the allocation of an IP address, initiating service, and the establishment of tunneling between the different elements within the network, (i.e., RAN, SGSN, GGSN, IMS, and the like). The present invention allows for the activation of multiple PDP contexts using a single step secondary PDP context activation, where each service is associated with certain service bearers in the Core Network (CN) and a specific RAB in the RAN. The present invention also allows for the establishment of multiple RABs which are mapped to one PDP context for different QoS requirements. These multiple PDP contexts can be established for special requirements, (e.g., bundled services), or when the WTRU connects to multiple PDNs.

The present invention reduces the delay for the secondary PDP context activation and any modifications thereof when more services are required. For example, a user configures a personal data assistant (PDA) terminal to activate VoIP services, Video conferencing, an E-mail account, and the like, when the PDA terminal powers up. According to the current procedures in TS 23.060, the WTRU performs each procedure individually and sequentially. The present invention reduces unnecessary steps that are used in activate secondary PDP context procedures. The WTRU requests additional bearers by sending a request to the RAN, (e.g., an eNodeB), which examines the request to see if the additional bearer can fit within the allocated resources of the current PDP context, (i.e., a bearer). When an additional bearer can be added, the eNodeB forwards the request to a mobility management entity (MME) for further examination.

The service type of the request determines whether a secondary PDP context is needed. A secondary PDP context is required if the service requested is provided by a different PDN at a different anchor node. If the same PDN and anchor node provide the requested service, the MME forwards the service request to the anchor node to allocate the necessary resources and mapping of the network layer service access point identifier (NSAPI) requested by the WTRU to the new service bearer. The anchor node is informed by the tunnel endpoint identifier (TEID) of the supporting eNodeB in this process. After receiving an acknowledgment, the MME establishes the other end of the tunnel by sending an RAB establishment request to an eNodeB, which is updated with the anchor node TEID. The MME then requests that the WTRU update its RAB resources. The WTRU then responds with a completion notice to the eNodeB, which in turn informs the MME that the process has been successfully completed. If an error or counter timeout occurs at the MME, the MME proceeds to release the tunnel and the resources allocated previously.

The present invention is advantageous for the following reasons over the prior art: 1) several bearers are allocated within the primary PDP context; 2) single tunnel establishment vs. 3GPP (GPRS) two tunnels (new architecture); and 3) reduced number of steps, (combining the secondary PDP activation with an RAB establishment request).

### BRIEF DESCRIPTION OF THE DRAWINGS

A more detailed understanding of the invention may be illustrated from the following description of a preferred embodiment, given by way of example and to be understood in conjunction with the accompanying drawing wherein:

FIG. 1 shows a conventional primary PDP context activation procedure for Iu mode in a conventional wireless communication system;

FIG. 2 shows a conventional secondary PDP context activation Procedure for Iu mode in a conventional wireless communication system;

FIG. 3 is a flow diagram of conventional PDP context activation procedures in a conventional wireless communication system;

FIG. 4 is a signal flow diagram of PDP context activation procedures in an LTE system in accordance with one embodiment of the present invention;

FIG. 5 is a signal flow diagram of PDP context activation procedures in an LTE system in accordance with another embodiment of the present invention; and

FIG. 6 shows the establishment of multiple PDP contexts for multiple PDNs.

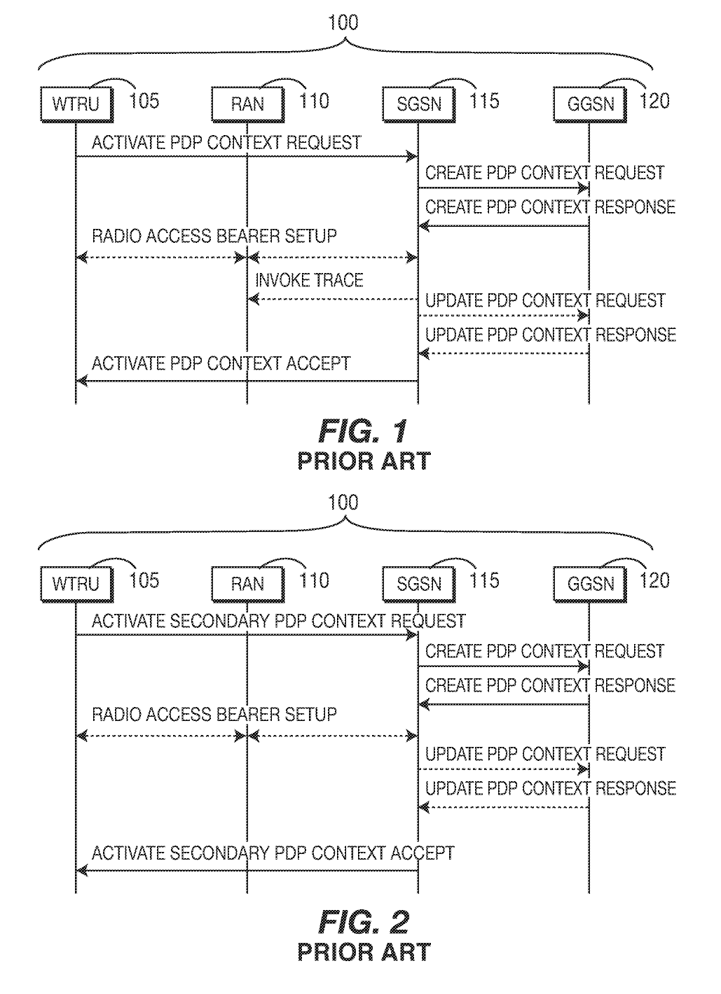

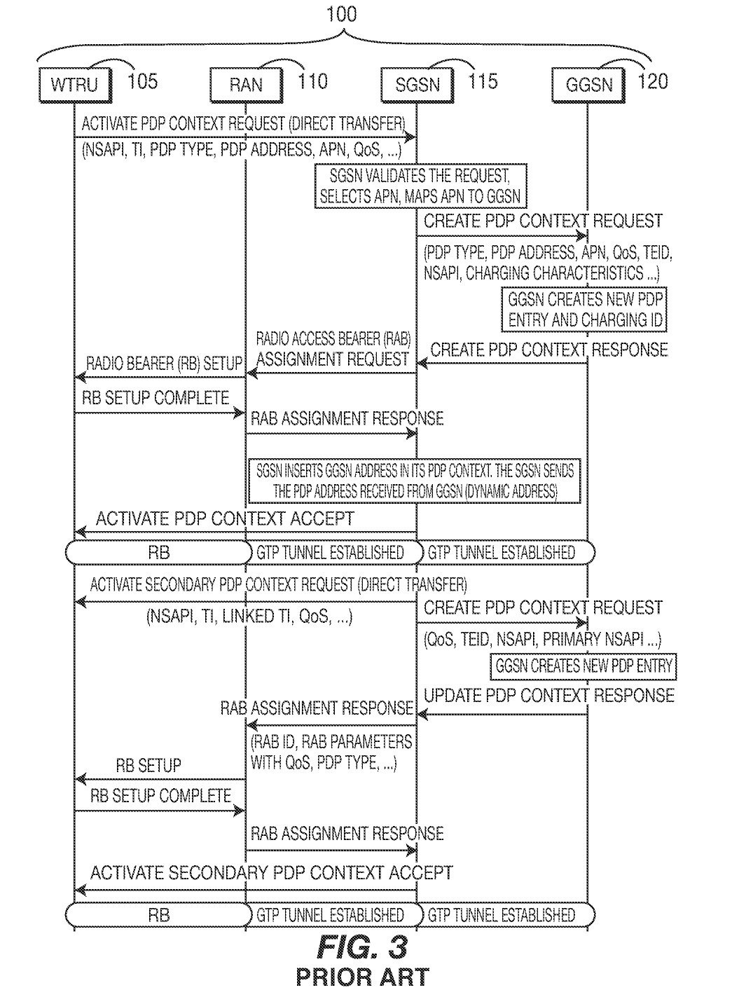

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

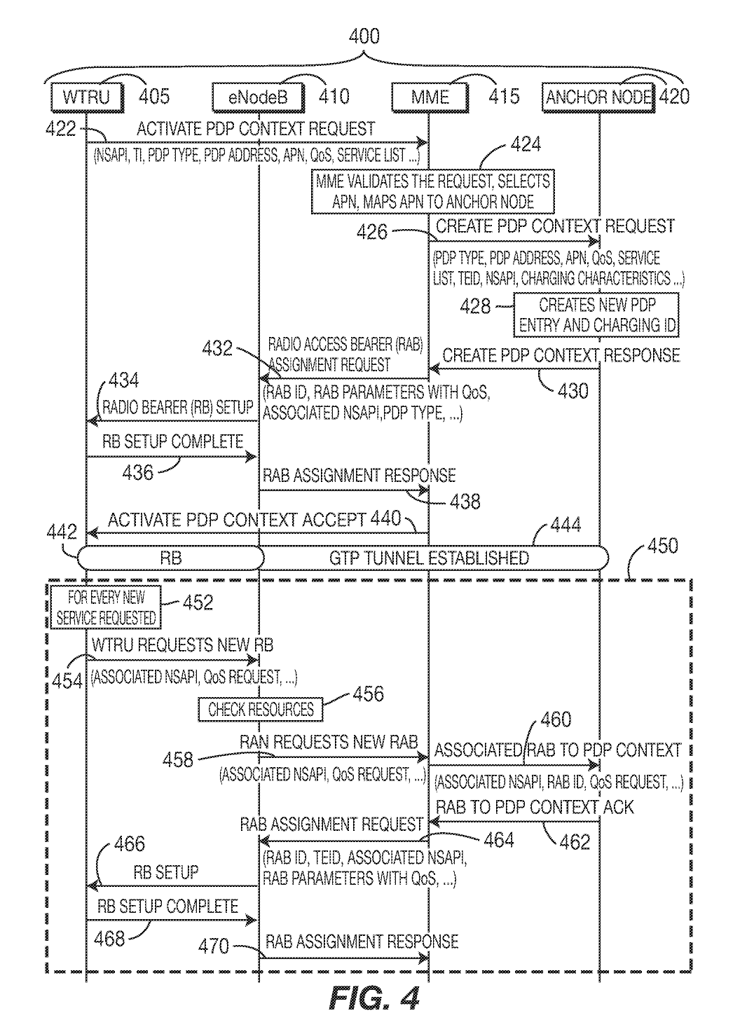

In accordance with one embodiment of the present invention, FIG. 4 shows the procedures for PDP context activation and RAB assignment in an LTE system 400 including a WTRU 405, an eNodeB 410, an MME 415 and an anchor node 420. No additional secondary PDP context activations are needed for multiple sets of services. Dynamic requests of new services are accommodated by RB establishments and releases between the WTRU 405 and the eNodeB 410.

Referring to FIG. 4, in step 422, the WTRU 405 sends an activate PDP context request message to the MME 415. The contents of the message include, for example, NSAPI, transaction identifier (TI), PDP type, PDP address, (if the static PDP address is requested), access point name (APN), QoS, service list, and the like.

Note that the meaning of QoS request is different from the current PDP context activation procedure. Currently, the QoS applies only for this PDP context. The primary and secondary PDP context and the RABs mapped to them respectively can have a different QoS. In accordance with the present invention, the QoS is a range that applies to all of the RABs belonging to this PDP context, and it is likely that the WTRU 405 has only one PDP context for one IP address. The service list is a new parameter that provides the range of IP services that the WTRU 405 desires to establish with a core network (CN) under this PDP context.

In step 424, the MME 415 validates the activate PDP context request using a PDP type, PDP address, and APN provided by the WTRU 405. The MME 415 may restrict the requested QoS attributes, given its capabilities and the current load. The MME 415 sends a create PDP context request message, (PDP type, PDP address, APN, QoS negotiated, TEID, NSAPI, mobile station international integrated services digital network (ISDN) number (MSISDN), and the like), to the affected anchor node 420 (step 426). In step 428, for a valid PDP context request, the anchor node 420 will create a PDP entry. A different PDP is associated with each service requested. In this case, if all the services are provided via/by the same gateway, (i.e., anchor node 420), then there is one IP address and multiple port numbers. Each port number is associated with the service being activated. Additionally, in step 428, the anchor node 420 creates charging information for a valid PDP context request. Each service will be charged separately and according to different criterion. For example, video calls may be charged differently than text messages. Therefore, each service will be have a different charge ID. The anchor node 420 then sends a create PDP context response message to the MME 415 (step 430).

In steps 432, 434, 436 and 438, RAB setup is performed by the RAB Assignment /RB Setup procedures as it is done currently. The QoS exchanged between the RAN, (e.g., the eNodeB 510), and the CN, is for the specific RAB, and it should be within the negotiated QoS of the PDP context. The identity of the PDP context associated with this RAB is passed to the WTRU 405. In case that the QoS of the RAB is downgraded from the negotiated QoS of the PDP context, no PDP context modification is required since more RABs/RBs can be allocated for the same service when more resources are available.

If all of the above steps are successfully executed, the MME 415 returns an activate PDP context accept message, (PDP type, PDP address, TI, QoS negotiated, radio priority, and the like), to the WTRU 405 (step 440). At this point, the first RB associated with the PDP context and GPRS tunneling protocol (GTP) tunnel between the anchor node 420 and the eNodeB 410 are established (steps 442, 444).

As shown by procedure 450 of FIG. 4, for every new service requested at the WTRU 405, a new RB/RAB needs to be established (step 452). The WTRU 405 sends a message to the eNodeB 410 to request a new RB for the new service (step 454). A service related QoS request can be passed with the message. The eNodeB 410 checks the availability of resources (step 456), and may deny the request if there are not enough resources. The eNodeB 410 forwards the request to the MME 415 for a new RAB (step 458). Since the WTRU 405 knows the NSAPI from the first RAB establishment, (i.e., the RAB established during the Primary PDP context activation), the MME 415 will know to which PDP context the request should associate.

The MME 415 informs the anchor node 420 that there is a new RAB established for a certain PDP context (step 460). The anchor node 420 allocates the necessary resources for the service at the end of the tunnel, updates charging and routing information, and sends a response back to MME 415 (step 462).

The RAB assignment and RB setup procedures (steps 464, 466, 468 and 470 are performed in a conventional manner. Steps 464, 466, 468 and 470 may be performed in parallel with steps 460 and 462, which can reduce delay. The steps of procedure 450 are iterative whenever there is a new service requested at step 452.

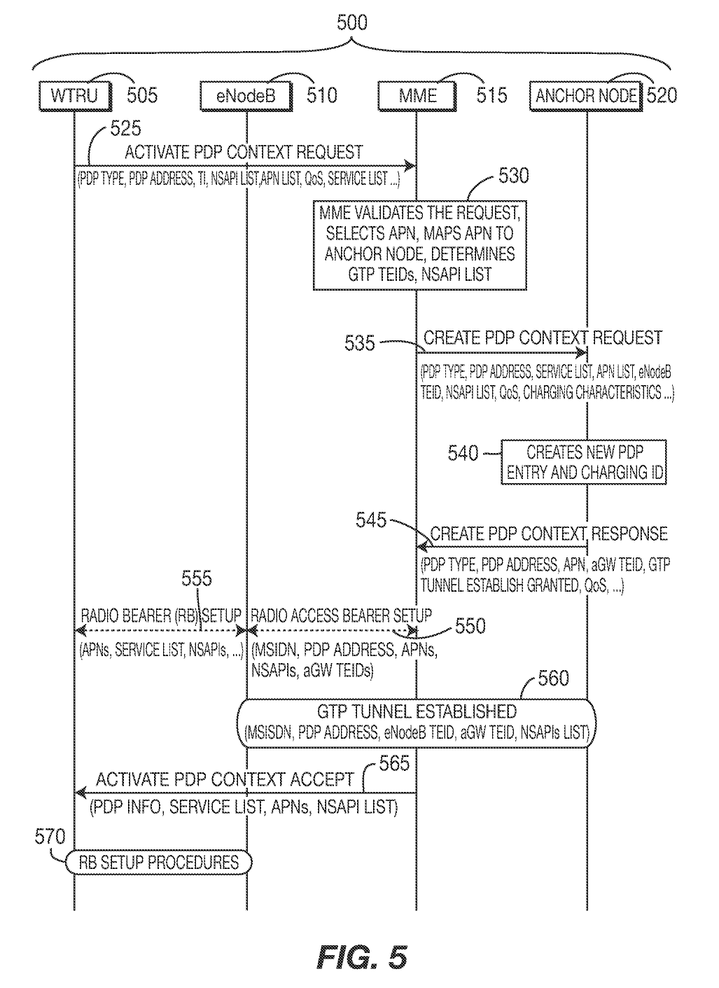

In accordance with another embodiment of the present invention, FIG. 5 shows the procedures for PDP context activation and RAB assignment in an LTE system 500 including a WTRU 505, an eNodeB 510, an MME 515 and an anchor node 520. In the proposed procedure, no additional secondary PDP context activations are needed for multiple sets of services. Dynamic requests of new services are accommodated by RB establishments and releases between the WTRU 505 and the eNodeB 510.

Referring to FIG. 5, the WTRU 505 sends an activate PDP context request message to the MME 515 (step 525). In the request, a list of NSAPI, APN, services, and the corresponding QoS requirements are specified. Note that different from a conventional PDP context activation procedure which gives one NSAPI and one APN only, the proposed procedure will have a list of NSAPI, services, and APNs to be negotiated and established in one PDP context activation procedure. If different requests of services occur later on, no additional PDP context activation procedures are required, thus limiting the signaling between the WTRU 505 and the eNodeB 510.

Still referring to FIG. 5, in step 530, the MME 530 validates the activate PDP context request, selects at least one APN, maps the APN to the anchor node 520, determines GTP TEIDs and a NSAPI list. The WTRU 505 lists all of the services that need to be activated using the list of APNs. Each service is marked by a different NSAPI, and a QoS profile. In step 535, the MME 515 sends a create PDP context request message to the anchor node 520. In step 540, for a valid PDP context request, the anchor node 520 will create a PDP entry. A different PDP is associated with each service requested. In this case, if all the services are provided via/by the same gateway, (i.e., anchor node 520), then there is one IP address and multiple port numbers. Each port number is associated with the service being activated. Additionally, in step 540, the anchor node 520 creates charging information for a valid PDP context request. Each service will be charged separately and according to different criterion. For example, video calls may be charged differently than text messages. Therefore, each service will be have a different charge ID.

At this point, the PDP context activation procedure is completed at the anchor node 520. The anchor node 520 then starts the acknowledgment phase of the operation by sending a create PDP context response message back to the MME 515, (step 545) which ensures that the RAN, (e.g., the eNode B 510), is aware of multiple tunnels being activated (step 550). The MME sends the information related to the number of services being activated and the associated ASAPI, PDP address, Gateway TEID, WTRU ID (temporary ID), so that each traffic flow is routed accordingly. The RAN, (e.g., the eNode B 510), then activates a RAB for each service and maps each flow to the associated IDs (step 555) to establish the tunnels (step 560), (direct tunnel or traditional GPRS dual tunnels, (RANAP and GTP)). In step 565, the MME 515 concludes the activation procedures by informing the WTRU 505 that the activation process was a success. The MME 515 sends a list of all of the successfully activated services. In case of a failure to activate a certain service, the MME 515 indicates the failed service and the reason for the failure. In step 570, the WTRU 505 and/or the RAN, (e.g., the eNodeB 510), may activate/deactivate the physical RBs/channels based on the availability of data flows to be transmitted.

For more services need to be established later, the above procedure will be limited to RB setups between WTRU 505 and the eNodeB 510 only.

During the activation of PDP context, the RAN and CN negotiate the QoS parameters for the PDP context, e.g., maximum bit rate, guaranteed bit rate, maximum delay, etc. The QoS profile is then passed to RAN in the immediate RAB assignment procedure. The QoS requirements of all the RABs/RBs allocated under the PDP context should be within the QoS restriction of the PDP context.

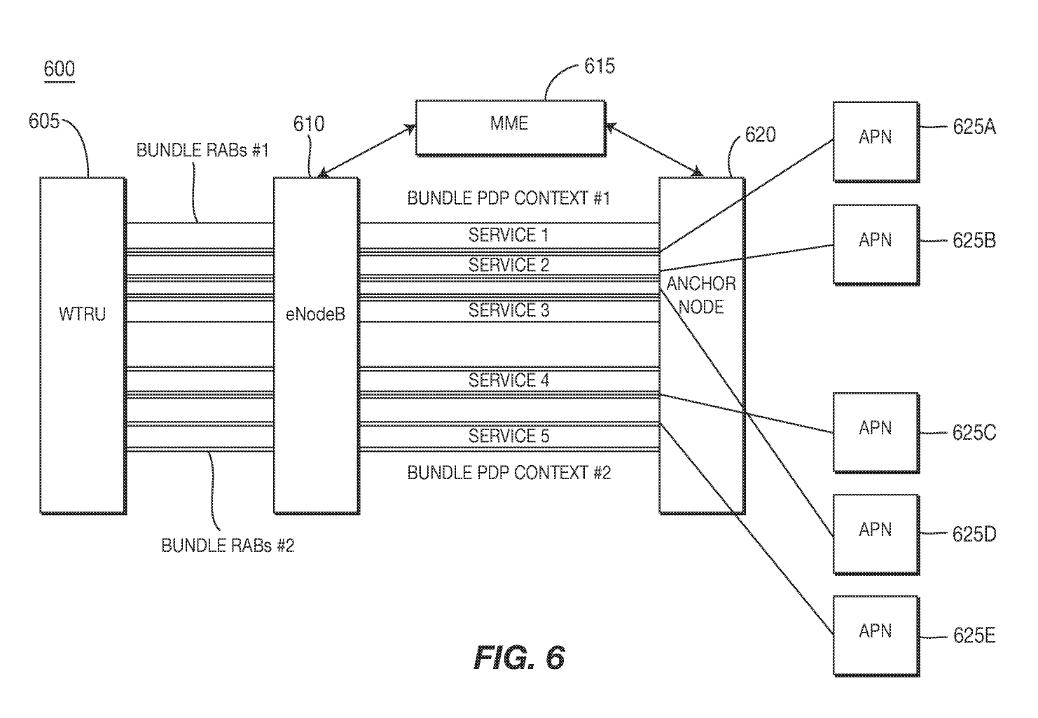

FIG. 6 shows multiple PDP contexts that are established for multiple PDNs in a wireless communication system 600. The system 600 includes a WTRU 605, an eNodeB 610, an MME 615, an anchor node 620 and APNs 625A-625E. If a new service requires a new APN, and thus a new access gateway, the MME 615 has to allocate a new tunnel between the eNodeB 610 and the new access gateway. The WTRU 605 is likely to get a different IP address from each PDN. Thus, a different PDP context is established. The procedures to establish PDP context are the same as described above.

With the proposed PDP context procedure, one PDP context is enough for multiple services of one IP address for the WTRU 605. Establishing a secondary PDP context can be optional, for example, if the operator wants to bundle certain services under the secondary PDP context. The handling of the secondary PDP context is the same as what it is done now.

Multiple RABs/RBs can be established and associated with the PDP context. The eNodeB 610 should be able to allow for multiple radio bearers for multiple streams as long as the bit rate and delay budget, (set during the PDP context activation), is not violated. In case the request for additional bearers from the eNodeB violate the QoS restrictions, the eNodeB 610 informs the WTRU 605 that the existing request requires modification of the PDP context and/or the activation of the secondary PDP context. The number of the parallel flows allowed for a PDP context can be defined. If the WTRU 605 has exhausted the allowed service, its request should be denied.

Currently, there is a one-to-one relationship between NSAPI, RAB, and PDP context. In the packet domain, there is also a one-to-one relationship with RB Identity. With the proposed change of the PDP context procedures, a new mapping needs to be established. The meaning of NSAPI will remain the same. In the WTRU 605, NSAPI identifies the PDP service access point (SAP). In the MME 615 and the anchor node 620, NSAPI identifies the PDP context associated with a mobility management (MM) context, which indicates what state the WTRU 605 is in. The MM context has all the information related to the WTRU 605 while operating in the network, such as QoS, different security information, and the like. The RAB ID should have the information of both the NSAPI, (i.e., the PDP context the RAB is associated with), and a unique ID for the RAB. Thus, each RAB is mapped to a PDP context. The method of how to form the RAB ID is up to implementation. The RB ID can be the same as a RAB ID.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a long term evolution (LTE) communication system including a wireless transmit/receive unit (WTRU), an evolved Node-B, a mobility management entity (MME) and an anchor node, a method comprising:
(a) establishing a first radio bearer associated with packet data protocol (PDP) context and a general packet radio service (GPRS) tunneling protocol (GTP) between the anchor node and the evolved Node-B;
(b) the WTRU sending a message to the evolved Node-B to request a new radio bearer (RB) for a new service;
(c) the evolved Node-B forwarding the message to the MME, wherein the MME maps access point names (APNs) to the anchor node, determines GTP tunnel endpoint identifiers (TEIDs) and a network layer service access point identifier (NSAPI) list; and
(d) the MME informing the anchor node that there is a new radio access bearer (RAB) established for a certain PDP context.

2. The method of claim 1 wherein the anchor node allocates the necessary resources for the service at the end of the tunnel, updates charging and routing information, and sends a response back to MME.

3. The method of claim 1 wherein a service related quality of service (QoS) request is passed with the message.

4. The method of claim 1 wherein the evolved Node-B checks for the availability of resources.

5. The method of claim 4 wherein the evolved Node-B denies the message if there are not enough resources.

6. A long term evolution (LTE) communication system comprising:
(a) an evolved Node-B;
(b) a wireless transmit/receive unit (WTRU) configured to send a message to request a new radio bearer (RB) for a new service;
(c) an anchor node configured to establish a first radio bearer between the anchor node and the evolved Node-B, wherein the first radio bearer is associated with packet data protocol (PDP) context and a general packet radio service (GPRS) tunneling protocol (GTP); and
(d) a mobility management entity (MME) configured to map access point names (APNs) to the anchor node, determine GTP tunnel endpoint identifiers (TEIDs) and a network layer service access point identifier (NSAPI) list, and inform the anchor node that there is a new radio access bearer (RAB) established for a certain PDP context.

7. The system of claim 6 wherein the anchor node allocates the necessary resources for the service at the end of the tunnel, updates charging and routing information, and sends a response back to MME.

8. The system of claim 6 wherein a service related quality of service (QoS) request is passed with the message.

9. The system of claim 6 wherein the evolved Node-B checks for the availability of resources.

10. The system of claim 9 wherein the evolved Node-B denies the message if there are not enough resources.

11. In a long term evolution (LTE) communication system including a wireless transmit/receive unit (WTRU), an evolved Node-B, a mobility management entity (MME) and an anchor node, a method comprising:
(a) the WTRU sending an activate packet data protocol (PDP) context request message to the MME, the activate PDP context request message including a list of network layer service access point identifiers (NSAPIs), services and access point names (APNs) to be negotiated and established in a single PDP context activation procedure;
(b) the MME validating the activate PDP context request and sending a create PDP context request message to the anchor node;
(c) the anchor node creating a new PDP entry and charging identifier;
(d) the anchor node sending a create PDP context response message to the MME;
(e) setting up radio access bearers (RABs) between the evolved Node-B and the MME; and
(f) setting up radio bearers (RBs) between the WTRU and the evolved Node-B.

12. The method of claim 11 wherein the MME maps APNs to the anchor node, determines general packet radio service (GPRS) tunneling protocol (GTP) tunnel endpoint identifiers (TEIDs) and a NSAPI list, and the MME informs the anchor node that there is a new RAB established for a certain PDP context.

13. The method of claim 12 wherein the anchor node allocates the necessary resources for the service at the end of the tunnel.

14. The method of claim 11 wherein a service related quality of service (QoS) request is passed with the activate packet PDP context request message to the MME.

15. The method of claim 11 wherein the evolved Node-B checks for the availability of resources.

16. A long term evolution (LTE) communication system comprising:
(a) an evolved Node-B;
(b) a wireless transmit/receive unit (WTRU) configured to send an activate packet data protocol (PDP) context request message including a list of network layer service access point identifiers (NSAPIs), services and access point names (APNs) to be negotiated and established in a single PDP context activation procedure;
(c) an anchor node configured to receive a create PDP context request message to the anchor node, to create a new PDP entry and charging identifier, and send a create PDP context response message; and
(d) a mobility management entity (MME) configured to receive the create PDP context response message.

17. The system of claim 16 wherein radio access bearers (RABs) are set up between the evolved Node-B and the MME, and radio bearers (RBs) are set up between the WTRU and the evolved Node-B.

18. The system of claim 17 wherein the MME maps APNs to the anchor node, determines general packet radio service (GPRS) tunneling protocol (GTP) tunnel endpoint identifiers (TEIDs) and a NSAPI list, and the MME informs the anchor node that there is a new RAB established for a certain PDP context.

19. The system of claim 18 wherein the anchor node allocates the necessary resources for the service at the end of the tunnel.

20. The system of claim 17 wherein a service related quality of service (QoS) request is passed with the activate packet PDP context request message to the MME.

21. The system of claim 17 wherein the evolved Node-B checks for the availability of resources.
